(19) United States
(12) Patent Application Publication
(10) Pub. No.: US 2013/0219512 A1
(43) Pub. Date: Aug. 22, 2013

(54) APPARATUSES AND METHODS FOR PROCESSING FILE CONTENT USING DIGITAL RIGHTS MANAGEMENT (DRM) IN WEB BROWSER

(71) Applicant: ConDel International Technologies Inc., (US)

(72) Inventors: Yeu-Chung LIN, Chang-hua (TW); Kwok-Tsen TSENG, Longtan Township (TW)

(73) Assignee: CONDEL INTERNATIONAL TECHNOLOGIES INC., George Town (KY)

(21) Appl. No.: 13/845,758

(22) Filed: Mar. 18, 2013

(51) Int. Cl. G06F 21/60

(52) U.S. Cl. CPC G06F 21/60
USPC 726/27

(57) ABSTRACT

An electronic device for processing file content using Digital Rights Management (DRM) is provided with a DRM agent, a plug-in, and a web browser. The DRM agent module processes DRM-protected content associated with an electronic file. The plug-in enables access of electronic file. The web browser includes a module which is to be invoked during loading of the DRM-protected content associated with electronic file and is installed with the DRM agent. Upon receiving a request for electronic file, the module determines whether electronic file is DRM protected. After determining that electronic file is DRM protected, the module activates the processing of the DRM-protected content by the DRM agent to obtain electronic file portion-by-portion such that the web browser directly accesses or uses a corresponding native player or a corresponding plug-in of the web browser to access electronic file with obtained portions, respectively.

### BACKGROUND OF THE INVENTION

1. Field of the Invention

The invention generally relates to the field of content processing, and more particularly, to apparatuses and methods for processing content with or without Digital Rights Management (DRM) protected by installing DRM agents in a specific module of a web browser.

2. Description of the Related Art

In recent years, there has been an exponential growth in Internet use, coupled with advances in technology, which has resulted in software programs, music, books, video games, and even full-length movies, becoming widely available in high-quality, easily reproducible and easily transmitted digital formats. Correspondingly, various content protection methods have been developed for stopping rampant piracy and unauthorized distribution by controlling access to the protected content. Digital Rights Management (DRM) is an access control technology that is wildly used by hardware manufacturers, publishers, copyright holders, and individuals with the intent to limit the use of digital content and devices. DRM technologies attempt to control use of digital content by preventing access, copying or conversion to other formats by end users. The original digital content to be protected is packaged and encrypted by a DRM server, and the DRM-protected content may be provided locally or accessible remotely via the Internet to users. For the case where the DRM-protected content is provided locally, an associated software application, such as Windows Media Player, QuickTime, or others, installed with a DRM agent is invoked for loading or executing the DRM-protected content. Specifically, the DRM agent first decrypts and un-packages the DRM-protected content to obtain the original digital contents, and then provides the original digital content to be accessed by the associated software application according to one or more Rights Objects (ROs) which specify the permissions for the uses of the original digital content. For the case where the DRM-protected content is accessible remotely, a web browser is launched to obtain the DRM-protected content according to a certain communication protocol, such as the Hyper Text Transfer Protocol (HTTP). Next, similar to the first case described above, an associated software application installed with a DRM agent is responsible for loading or executing the DRM-protected content.

Note that, the conventional implementation of digital content protection using DRM is to install the DRM agent in the software applications. For example, the DRM agent may be installed in a VLC media player for playing the DRM-protected multimedia files, or installed in a Sumatra Portable Document Format (PDF) viewer for viewing the DRM-protected electronic files with the file extension of “pdf”. If several data formats are used for the original digital content, it is required to install a respective DRM agent in each of the associated software applications.

However, the conventional implementation has a huge drawback as it requires the source code of the software applications for the DRM agent to be installed therein, or worse, it requires the source code of the Operating System (OS) and the configurations of the hardware resources for the DRM agent to be installed in the kernel of the OS. It is very likely that the company developing the software applications or OS will not be willing to authorize the use of its source code to a third party. Also, the cost for authorization may be high, and the complexity of installing the DRM agent may be great.

### BRIEF SUMMARY OF THE INVENTION

In one aspect of the invention, an electronic device for processing file content using DRM is provided. The electronic device comprises a DRM agent, a plug-in, and a web browser. The DRM agent module is configured to process DRM-protected content associated with an electronic file. The plug-in is configured to enable access of the electronic files. The web browser includes a module which is to be invoked during loading of the DRM-protected content associated with the electronic file and during loading of the electronic file without DRM protection, the module is installed with the DRM agent. The module is configured to determine whether the electronic file is DRM protected upon receiving a request for the electronic file. After determining that the electronic file is DRM protected, the module activates the processing of the DRM-protected content by the DRM agent to obtain the electronic file portion-by-portion such that the web browser directly accesses or uses a corresponding native player or a corresponding plug-in of the web browser to access the electronic file with the obtained portions, respectively, wherein the processing of the DRM-protected content is activated when the web browser is required to access the DRM-protected content.

In another aspect of the invention, a method for processing file content using DRM in an electronic device is provided. The method comprises the steps of providing a web browser comprising a module which is configured to be invoked during loading of the DRM-protected content associated with an electronic file and during loading of the electronic file without DRM protection and the module is installed with the DRM agent for processing DRM-protected content associated with the electronic file; determining, by the module, whether the electronic file is DRM protected upon receiving a request for the electronic file; and activating, by the module, the processing of the DRM-protected content by the DRM agent to obtain the electronic file portion-by-portion, so as to directly access or use a corresponding native player or a corresponding plug-in of the web browser to access, by the web browser, the electronic file with the obtained portions, respectively when determining that the electronic file is DRM protected, wherein the processing of the DRM-protected content is activated when the web browser is required to access the DRM-protected content.

In yet another aspect of the invention, an electronic device for processing file content using DRM is provided. The electronic device comprises a plurality of DRM agents, a plurality of plug-ins, and a web browser. The DRM agents supporting a plurality of DRM schemes are configured to process DRM-protected content associated with an electronic file using one of the DRM schemes. The plug-ins are configured to enable access of the corresponding electronic files. The web browser includes a module which is configured to be invoked during loading of the DRM-protected content associated with both the electronic file and during loading of the electronic file without DRM protection and the module is installed with the DRM agents. The module is configured to determine whether the electronic file is DRM protected upon receiving a request for the electronic file and determines a specific DRM scheme of the DRM schemes which is used to protect the electronic file. After determining that the electronic file is DRM protected by the specific DRM scheme, the module activates the processing of the DRM-protected content by the corresponding DRM agent supporting the specific DRM scheme in the DRM module to obtain the electronic file portion-by-portion such that the browser directly accesses or uses a corresponding native player or a corresponding plug-in of the web browser to access the electronic file with the obtained portions, respectively, wherein the processing of the DRM-protected content is activated when the web browser is required to access the DRM-protected content.

Other aspects and features of the invention will become apparent to those with ordinary skill in the art upon review of the following descriptions of specific embodiments of the electronic devices and methods for processing file content using DRM.

### BRIEF DESCRIPTION OF DRAWINGS

The invention can be more fully understood by reading the subsequent detailed description and examples with references made to the accompanying drawings, wherein:

FIG. 1 is a block diagram illustrating the software architecture of an electronic device according to an embodiment of the invention;

FIG. 2 is a block diagram illustrating the hardware architecture of an electronic device according to an embodiment of the invention;

FIGS. 3A and 3B show a flow chart illustrating the operations of determination of whether the resource is DRM protected according to an embodiment of the invention;

FIG. 4 is a flow chart illustrating the method for processing file content using DRM in an electronic device according to an embodiment of the invention;

FIG. 5 is a schematic diagram illustrating the modules defined in the Chromium web browser according to an embodiment of the invention; and

FIG. 6 is a schematic diagram illustrating the invoking sequence of the involved classes during the loading of the DRM-protected contents associated with electronic files according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

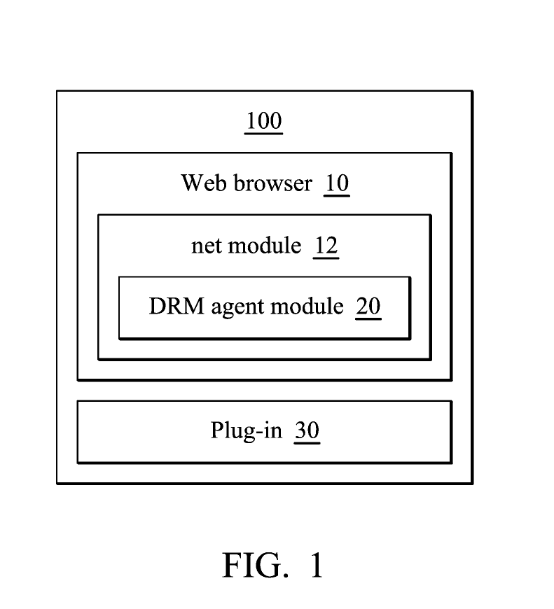

FIG. 1 is a block diagram illustrating the software architecture of an electronic device according to an embodiment of the invention. The electronic device may be a Personal Computer (PC), a laptop, a tablet PC, a smart phone, a multimedia player, a portable gaming device, a smart TV, or the like. The software architecture 100 of the electronic device contains a web browser 10, a DRM agent module 20, which contains a plurality of DRM agents appropriate to different DRM scheme, and one or more plug-ins 30, wherein the web browser 10 includes at least one module, such as a net module 12, a content module or the like, and the at least one module which performing content processing is installed with the DRM agent module 20. The web browser 10 is a software application which provides the functionality of a web browser for retrieving, presenting, and traversing information resources either in a local storage device or on a local/remote web page. Specifically, an information resource may be identified by a Uniform Resource Identifier (URI) and may be a web page, image, video, or other piece of content. Alternatively, the web browser 10 may also be used to access information provided by locally maintained electronic files. The web browser 10 may be Firefox, Chrome, Chromium, Internet Explorer, Opera, Safari, or a web browser constructed by Web Kit or Web View SDK bearing similar functions as the aforementioned one.

The net module 12, used herein as a preferable embodiment, is a file-loading entry point which is an entry point for loading a requested resource in the web browser 10 when a request for resources is received. The net module 12 provides a set of Application Programming Interfaces (APIs) for users to handle the loading of the requested resource (e.g. a URL request file). Note that, the net module 12 is open-sourced in the Chromium web browser for various operating systems, for example in Windows.

The plug-ins 30 may also be referred to as web browser extensions or add-ons, which generally refer to computer programs for extending the functionalities of a web browser, e.g., the web browser 10. In this embodiment, the plug-ins 30 enable the access of certain electronic files, including multimedia/data files and program files for the web browser 10. For example, the plug-ins 130 may contain a Flash plug-in for providing functionality similar to that of the Adobe Flash Player, and the executable file corresponding to the Flash plug-in is a program file with the file extension “swf”. The plug-ins 130 may contain a WMP plug-in for providing functionality similar to that of the WMP, and the executable file corresponding to the WMP plug-in is an electronic file with a file extension of either “wmv” or “wma”. The plug-ins 130 may contain a SilverLight plug-in for providing functionality similar to that of the SilverLight Player, and the executable file corresponding to the SilverLight plug-in is a program file with the file extension “xap”. The plug-ins 130 may contain a Unity 3D plug-in for providing functionality similar to that of the Unity 3D Game Engine, and the executable file corresponding to the Unity 3D plug-in is a program file with a file extension of either “unity3d” or “js”. The plug-ins 30 may contain an Adobe Reader plug-in for providing the functionality similar to the Adobe Reader, and the electronic files corresponding to the Adobe Reader plug-in are the data files with the file extension of “pdf”. Note that different types of plug-in can be installed at the same time so that the web browser can perform versatile content access works.

Specifically, because the plug-ins 30 are installed in the web browser 10, the web browser 10 may detect the existence of the plug-ins 30, and when the web browser 10 is required to access the electronic files accessible to the plug-ins 30, it may invoke the plug-ins 30, i.e., using the plug-ins 30, to access the electronics files. Note that, during the access of the electronic files, any input and output associated with the electronic files are made through the web browser 10. Taking a Flash file as an example, during execution, if the Flash file requires a user to input a command, the command will be received by the web browser 10 via an I/O device (not shown), such as a keyboard, a touch pad, or a touch panel, etc., and then forwarded to the plug-ins 30. Likewise, if the Flash file requires the invoking of other Flash files or multimedia files, the requirement will be directed to be handled by the web browser 10.

The DRM agent module 20 is a trusted entity which comprises a plurality of DRM agents. Each individual DRM agent is in compliance with the DRM protocol(s) of a specific DRM scheme, which is responsible for processing DRM-protected content according to one or more Rights Object (RO) corresponding to the DRM-protected content, which defines permissions for accessing the DRM-protected content in the electronic device. The processing includes decrypting and un-packaging of the DRM-protected content, and enforcing permissions and constraints associated with the DRM-protected content, as well as controlling access to the DRM-protected content. Note that, the DRM agent module 20 is installed in the web browser 10 by means of either building directly into the web browser source code, or being an external library to be statically or dynamically called by the web browser 10 whenever is needed, and the access to any DRM-protected content must be made through the web browser 10. Therefore, system performance and processing efficiency may be improved since the DRM-protected content may be accessed directly in the web browser 10.

Specifically, the DRM agent module 20 is installed in the file-loading entry point of the web browser 10 (e.g. the net module 12) so that the processing of the DRM-protected content in the DRM agent module 20 is activated when the web browser 10 is required to access DRM-protected content. Taking the Google Chrome web browser as a preferred example, the installation of the DRM agent module 20 in the file-loading entry point is particularly feasible since the Google Chrome web browser is an open-source web browser and the source code of the Google Chrome web browser is free and available to all, but the invention is not limited thereto. Please note that the Google Chrome web browser installed with the DRM agent module 20 is different from the genuine Google Chrome web browser released to the public by Google™, and it may be referred to as a custom Google Chrome web browser made and used specifically in this invention. In one embodiment, the installation of the DRM agent module 20 is performed by inserting the source code of the DRM agent module 20 into the file-loading entry point (e.g. the net module 12) of the web browser 10. In another embodiment, the installation of the DRM agent module 20 is performed by providing a code routine which was written using the Application Programming Interface (API) of the DRM agent module 20 for calling external libraries of the DRM agent module 20 statically or dynamically, and inserting the code routine in the file-loading entry point of the web browser 10.

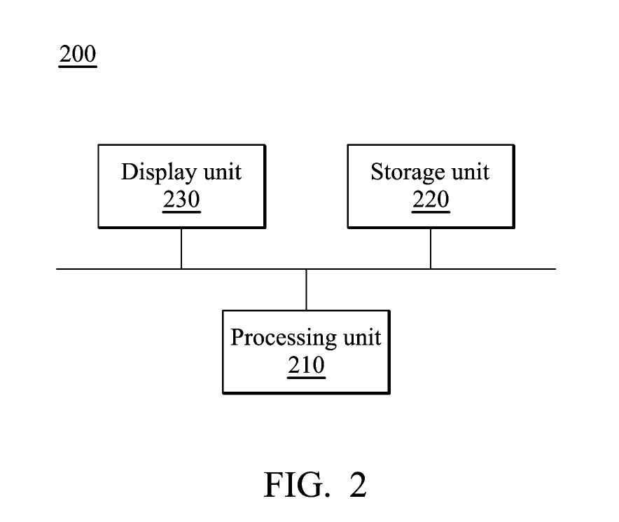

FIG. 2 is a block diagram illustrating the hardware architecture of an electronic device according to an embodiment of the invention. The hardware architecture 200 of the electronic device contains a processing unit 210, a storage unit 220, and a display unit 230. The processing unit 210 may be a general-purpose processor or a Micro-Control Unit (MCU) of the electronic device. The storage unit 220 may be a volatile memory, such as a Random Access Memory (RAM), a non-volatile memory, such as a flash memory, a hard disk, an optical disk, or any combination thereof, for storing the DRM-protected content and the program code or machine code of the web browser 10, the DRM agent module 20, and the plug-ins 30, which when loaded and executed by the processing unit 210, may perform the respective functions mentioned above. In addition, the storage unit 220 may also store the RO(s) corresponding to the DRM-protected content, wherein the DRM-protected content and the RO may be received from a DRM server (not shown) remotely located on the Internet, or may be read out from another storage medium (not shown) accessible when coupled to the electronic device. The display unit 230 may be a Cathode Ray Tube (CRT) screen, a Liquid Crystal Display (LCD), a plasma display panel, or the like, for displaying a graphic user interface where the user may interact with a web browser presented therein. Although not shown, the hardware architecture 200 may comprise other functional units, such as a keyboard/keypad, a mouse, a touchpad, or a communication unit, such as an Ethernet card/chipset, a Wireless-Fidelity (WiFi) card/chipset, or a Baseband and Radio Frequency (RF) chipset for cellular communications.

Specially, the net module 12 may first determine whether the requested resource is DRM protected upon receiving a request for loading a resource and if so, decide which DRM scheme is used to protect the content and select the corresponding DRM agent in DRM agent module 20, then activates the processing of the DRM-protected content of the DRM agent to obtain the requested resource (e.g. an electronic file) portion-by-portion. Specifically, the DRM agent module 20 installed into a set of methods or classes in the net module 12, which are invoked during the loading of the DRM-protected content associated with the requested resource, so that the processing of the DRM-protected content by the DRM agent module 20 is activated when the web browser 10 is required to access the DRM-protected content associated with the requested resource.

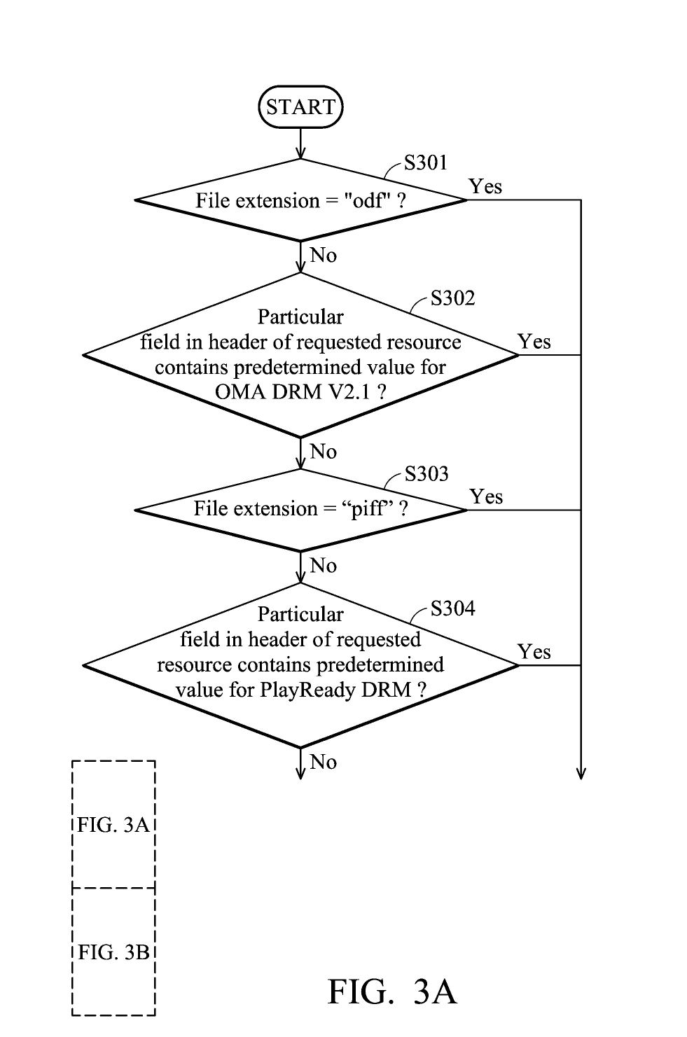

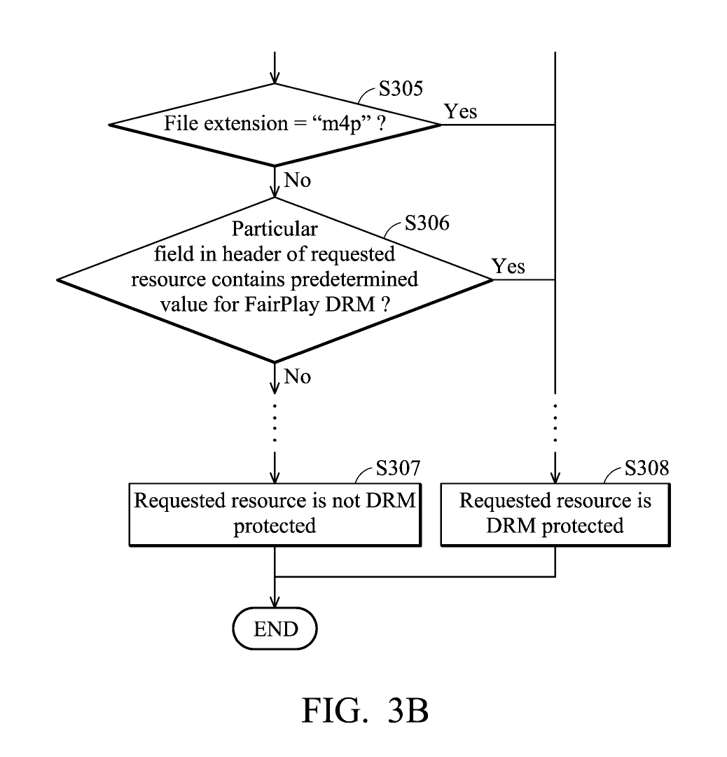

The determination of whether the requested resource is DRM protected by a specific DRM scheme may be performed according to a file extension and/or a particular field in the header of the requested resource. FIGS. 3A and 3B show a flow chart illustrating the determination of whether the resource is DRM protected and which DRM scheme is applied to protect the resource according to an embodiment of the invention. In this embodiment, it is checked whether the requested resource is DRM protected and in compliance with the one of the DRM schemes which are supported by the DRM agent module 20, such as OMA DRM v2.1, PlayReady DRM, and FairPlay DRM, etc.

First, it is first checked if the requested resource is DRM protected in compliance with the OMA DRM v2.1, by determining whether the file extension is “odf” (step S301) and determining whether a particular field in the header of the requested resource contains a predetermined value for OMA DRM v2.1 (step S302). That is, the check is conducted by a specific API of the DRM agent corresponding to OMA DRM v2.1. If both of the determination results in the steps S301 and S302 are negative, it is subsequently checked if the requested resource is DRM protected in compliance with the PlayReady DRM, by determining whether the file extension is “piff” (step S303) and determining whether a particular field in the header of the requested resource contains a predetermined value for PlayReady DRM (step S304). If both of the determination results in the steps S303 and S304 are negative, it is subsequently checked if the requested resource is DRM protected in compliance with the FairPlay DRM, by determining whether the file extension is “m4p” (step S305), and determining whether a particular field in the header of the requested resource contains a predetermined value for FairPlay DRM (step S306). The check continues until either a DRM agent retrieve a correct value or all the DRM agents in the DRM agent module 20 are exhausted and cannot retrieve a correct value. If the determination results in the steps S306 and following steps (if any), are negative, it means that the requested resource is either protected by a DRM scheme which is not supported by one of the DRM schemes which are supported by the DRM agent module 20, or not DRM protected (step S307). Otherwise, if one of the determination results in the steps S301 to S306 and subsequent steps (if any) is positive, it means that the requested resource is DRM protected (step S308). Note that, the steps S302, S304, and S306 are performed by activating the DRM agent module 20 to use its API(s) of specific DRM agent(s) corresponding to specific DRM scheme(s) for reading the particular field in the header of the requested resource.

Alternatively, for the checking of whether the requested resource is DRM protected in compliance with the OMA DRM v2.1, only one of the steps S301 and S302 may be performed instead of performing both the steps S301 and S302. Likewise, for the checking of whether the requested resource is DRM protected in compliance with the PlayReady DRM and FairPlay DRM, only one of the steps S303 and S304 may be performed instead of performing both the steps S303 and S304, and only one of the steps S305 and S306 may be performed instead of performing both the steps S305 and S306. It is noted that an alternative embodiment is using the API(s) of the DRM agent module 20 to check the header of the requested source directly without checking the file extension first.

The installation of the DRM agent module 20 in the net module 12 may be implemented in the Start method, GetMimeType method, ReadRawData method, and Kill method of the URLRequestFileJob or URLRequestHttpJob subclass, depending on the scheme type (e.g., “file://” or “http://”) of the URL of the requested DRM-protected contents associated with an electronic file. The Start method further comprises a Resolve submethod and a DidResolve submethod. The Resolve submethod is used to determine whether the DRM-protected contents indicated with the URL received by the net module 12 exists, and if so, obtain attributes, such as the data size, and time (e.g., time for establishment, modification, or last access of the electronic file), etc., of the electronic file by activating the DRM agent module 20. The DidResolve submethod is used to move the file-reading pointer to the location of the electronic file by activating the DRM agent module 20, and determine the length of reading according to the data size provided by the Resolve submethod. The GetMimeType method is used to inquire the Multipurpose Internet Mail Extensions (MIME) type of the electronic file by activating the DRM agent module 20. Examples of MIME types may include “Text/Plain” for print text files and “Image/Joint Photographic Experts Group (JPEG)” for JPEG files as is generally known by those with ordinary skill in the art. The ReadRawData method is used to request for a memory block and read out the data content of the electronic file according to the file-reading pointer and length provided by the DidResolve submethod, and then storing the obtained portions or the entire electronic file in the memory block for subsequent use. For example, if the electronic file is a continuous media, such as a video file, the resource loader may require the data content by segments for several times. If the electronic file is an image file, the resource loader may require the entire data content for once. The Kill method is used to terminate the loading of the DRM-protected contents associated with the electronic file by activating the DRM agent module 20, when the electronic file has been successfully loaded, or when an error has occurred or a suspension is requested during the loading of the DRM-protected contents associated with the electronic file.

In one embodiment, the installation of the DRM agent module 20 may be performed by inserting the source code of the DRM agent module 20 in the Start method, the GetMimeType method, the ReadRawData method and the Kill method. In another embodiment, the installation of the DRM agent module 20 may be performed by providing a code routine which was written using the API(s) of the DRM agent module 20 for calling the libraries of the DRM agent module 20, and inserting the code routine in the Start method, the GetMimeType method, the ReadRawData method and the Kill method. A method or class which is installed with the DRM agent module 20 is overwritten and is different from a genuine method or class in the APIs of the net module for the Window OS system released to the public, and it may be referred to as a custom method or class made and used specifically in this invention. For example, the Start method is overwritten and is different from a genuine Start method in the APIs of the net module for the Window OS system released to the public, and it may be referred to as a custom method made and used specifically in this invention. The overwritten module can perform the originally designated functionalities of the genuine method or class when an electronic file, which is not protected by any DRM scheme supported by the DRM agent module 20, is activated. If a DRM protected file, using one of the DRM schemes supported by the DRM agent module 20, is activated, the overwritten method or class will use a determined DRM agent to assist the acquisition and processing of data and information which cannot be performed by the genuine method or class due to the DRM protection of electronic file, and either complete the originally designated functionalities of the method or class, or replace the original functionalities by ways which can facilitate the subsequent information processing. For instance, the genuine ReadRawData method read an electronic file from its URL and will pass the read data to the corresponding player to enable the play of display of this data. In contrast, the overwritten ReadRawData method will use the DRM agent to retrieve data from the DRM agent protected electronic file and store the data in a designated address in memory so that the data cannot be accessed by any unauthorized party. The data so stored can still be accessed by its corresponding player as the address in the memory will be given to the corresponding player by the overwritten method.

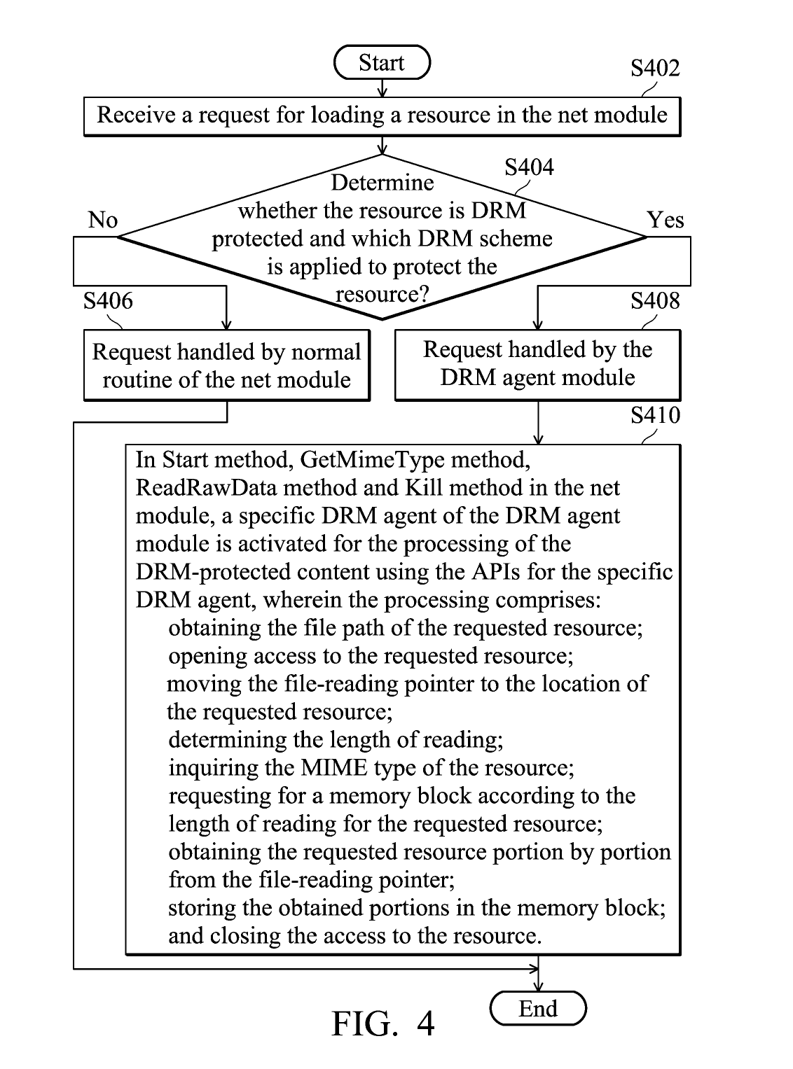

FIG. 4 is a flowchart of an embodiment of a method for processing file content using DRM in an electronic device of the invention. The method for processing file content can be used for an electronic device as shown in FIG. 1, such as a PDA, a smart phone, a smart TV, a mobile phone, an MID, a laptop computer, a car computer, a digital camera, a multi-media player or a game device. In this embodiment, the web browser 10 may be a specific web browser, e.g., the custom Google Chrome web browser, which is installed with a DRM agent module 20. The net module 12 in the web browser 10 is installed with the DRM agent module 20 so as to determine whether the resource is DRM protected according to a file extension or a header of the resource using the steps described in FIGS. 3A and 3B.

First, a request for loading a resource required in the web page is received by the net module 12 (step S402). Note that, the requested resources may be a webpage and the resources which are used in the webpage such as text file, image file, Cascade Styling Sheet, java script, audio/video files, or electronic files of which display are supported by the plug-ins.

Then, the net module 12 determines whether the resource is DRM protected and which DRM scheme is applied to protect the resource (S404). The net module 12 in the web browser 10 is installed with the DRM agent module 20 so as to determine whether the resource is DRM protected using one of the DRM schemes supported by the DRM agent module 20 according to a file extension or a header of the resource using the steps described in FIGS. 3A and 3B (i.e., use a specific kind of APIs of the DRM agents in the DRM agent module 20 one by one to check a specific field in the header until either an API of a DRM agent retrieves a correct value or all the DRM agents are exhausted and result negative response.)

Specially, the DidResolve submethod of the Start method is first used to determine whether the contents indicated with the URL received by the net module 12 exists, and if so, obtain attributes, such as the data size, and time (e.g., time for establishment, modification, or last access of the electronic file), etc., of the resource. Prior to the use of the Resolve submethod of the Start method, the determination of whether the resource is DRM protected is made and which DRM scheme is applied to protect this resource.

If the resource is not DRM protected or protected by a DRM scheme which is not supported by the DRM agent module 20 (No in step S404), the request is to be handled by the genuine, un-overwritten routine of the net module 12 (S406). In other words, the net module 12 performs the Start method, GetMimeType method, ReadRawData method, and Kill method of the URLRequestFileJob or URLRequestHttpJob subclass using its native APIs. Specially, the net module 12 performs the Resolve submethod to first obtain the file path of the requested resource, and then open access to the requested resource using its native APIs. The net module 12 then performs the DidResolve method to open access to the requested resource, move the file-reading pointer to the location of the requested resource, and determine the length of reading according to the data size provided by the Resolve submethod. Next, the net module 12 performs the GetMimeType method to inquire/obtain the MIME type of the resource using its native APIs and performs the ReadRawData method to requesting for a memory block according to the determined length of reading for the resource provided in the Start method, obtain the resource portion-by-portion from the file-reading pointer and store the obtained portions in the memory block using its native APIs. Thereafter, when the resource has been successfully loaded, the net module 12 performs the Kill method to terminate the loading of the resource contents and close the access to the resource using its native APIs.

If the determination result in the step S404 is positive, which means that the resource is DRM protected and a specific DRM agent corresponding to the determined DRM scheme of the DRM agent module 20 is determined/selected, the request is to be handled by the DRM agent module 20 and thus the specific DRM agent of the DRM agent module 20 is activated to process the resource (S408). In other words, the specific DRM agent of the DRM agent module 20 is activated to perform operations of the Start method, GetMimeType method, ReadRawData method, and Kill method as those performed in the normal routine of the net module 12 for processing the DRM-protected content to obtain the required data using APIs for the specific DRM agent. Specially, the DRM agent module 20 is activated in the Start method, GetMimeType method, ReadRawData method to perform the following operations for DRM processing using the APIs for the specific DRM agent (S410) and complete the jobs which the genuine, un-overwritten methods should achieve:

obtaining the file path of the requested resource;

opening access to the requested resource;

moving the file-reading pointer to the location of the requested resource;

determining the length of reading;

inquiring the MIME type of the resource;

requesting for a memory block according to the length of reading for the requested resource;

obtaining the requested resource portion by portion from the file-reading pointer;

storing the obtained portions in the memory block; and

closing the access to the resource.

The DRM-protected content refers to electronic files packaged and encrypted by the packager in a DRM server (not shown), wherein the content may contain the program files, and the multimedia/data files, such as text files, image files, and video files, etc. Also, the content may further contain a markup language file with the file extension of “html” and its associated resources such as text files, image files, Cascade Styling Sheet, java script, audio/video, etc., for the web browser to present visual effects or to call the program files and/or the multimedia files.

In response to the DRM-protected content being associated with an electronic file (e.g. a video/audio file), the net module 12 activates the processing of the DRM-protected content of the corresponding DRM agent to obtain the electronic file portion-by-portion. After that, when finishing the loading of the DRM-protected content associated with the electronic file, the Web browser 10 may use itself, a corresponding plug-in or a corresponding native player to access the electronic file with the obtained portions. The native player may be a QuickTime player, and the electronic files accessible to the QuickTime player have file extensions of “mp4”. The native player can be MediaPlayer in Android, and the electronic files accessible to the MediaPlayer have file extensions of “wmv”.

In response to the DRM-protected content being associated with an electronic file which is not supported by the web browser or its native player or the web page intents to use plug-in to present the electronic file, the net module 12 activates the processing of the DRM-protected content of the DRM agent to obtain the electronic file portion-by-portion, and uses the corresponding plug-in in the plug-ins 30 to access the electronic file with the obtained portions. Specifically, the DRM agent module 20 is installed to a set of methods or classes in the net module 12, which are invoked during the loading of the DRM-protected content associated with the electronic file, so that the processing of the DRM-protected content by the DRM agent module 20 is activated when the web browser 10 is required to access the DRM-protected content associated with the electronic file. After that, when finishing the loading of the DRM-protected content associated with the electronic file, the Web browser 10 may use the corresponding plug-in in the plug-ins 30 to access the electronic file.

In one embodiment, the DRM-protected content is downloaded and stored in the electronic device in advance, so that the DRM agent may process the DRM-protected content right after passing the RO check. In another embodiment, the DRM-protected content is stored remotely on the Internet and needs to be downloaded via the web browser before the DRM agent may start processing.

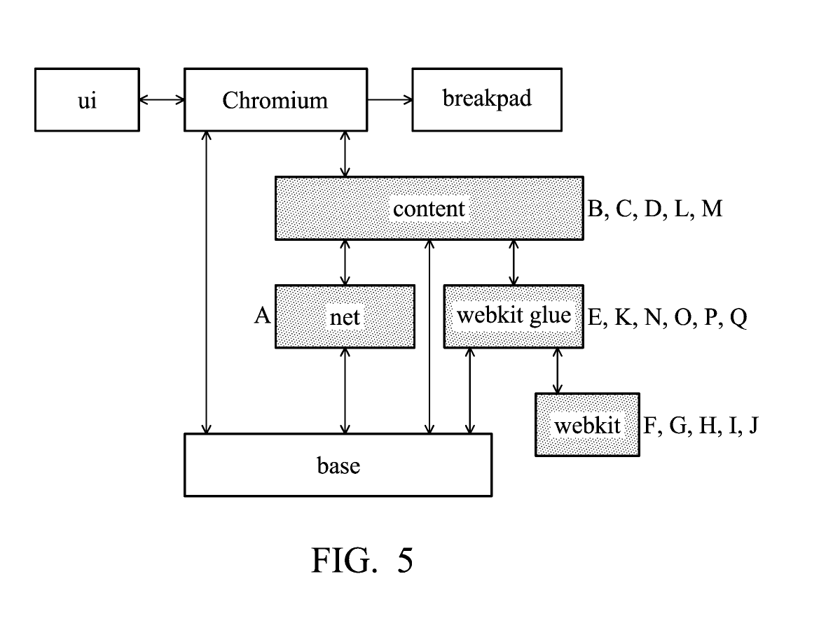

It is to be understood that, although the net module is used as an exemplary module in the embodiments, another module which is also invoked during the loading of the DRM-protected content may be used instead, such as a webkit module, a webkit glue module, a content module or the like defined in the Chromium web browser, and the invention is not limited thereto. The modules defined in the Chromium web browser is illustrated in FIG. 5, wherein the blocks with patterned background represent the possible modules which may be involved during the loading of the DRM-protected contents associated with the electronic files. As shown in FIG. 5, the webkit module, the webkit glue module and the content module defined in the Chromium web browser may also be used as an exemplary module. It is also noted that the version of a browser software might be changed and the nomenclature of modules, methods, classes might as well be changed or their functions might be reorganized and re-casted, but as long as the basic functionalities necessary for the deploying of DRM agent remain, the method taught in this invention still can be applied.

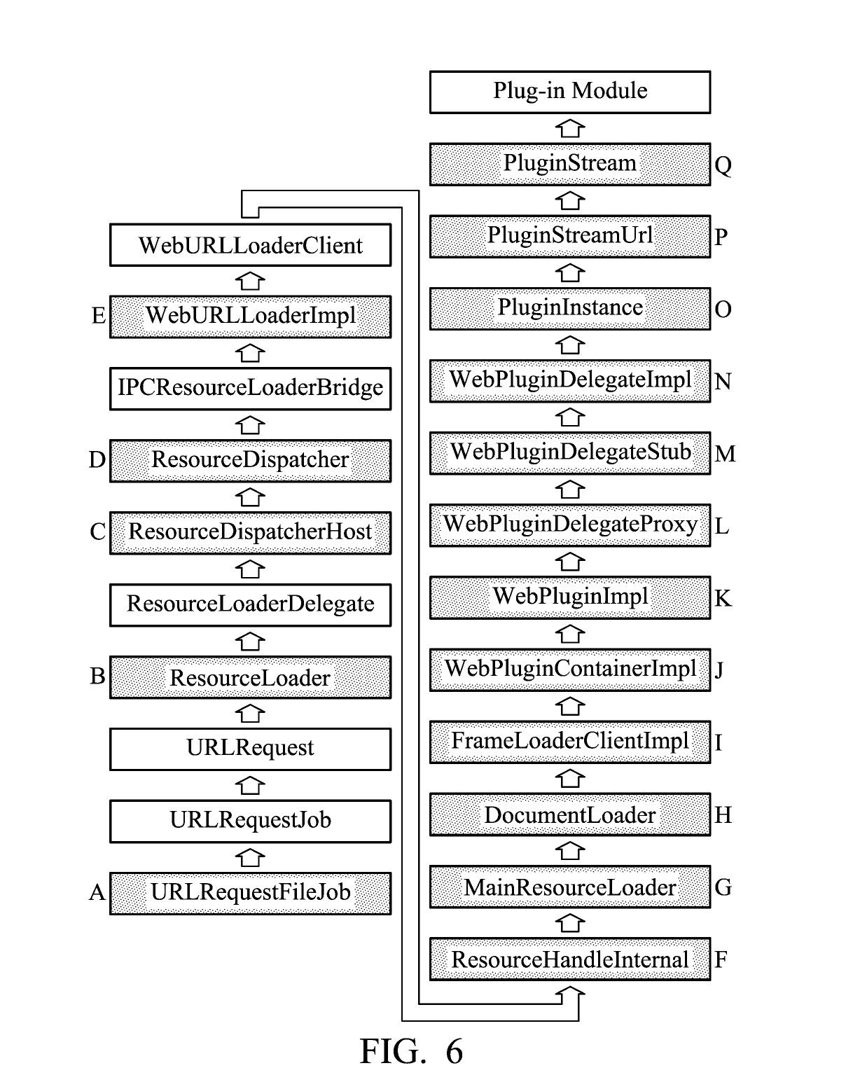

Taking the Chromium web browser as an example, the invoking sequence of the involved methods during the loading of the DRM-protected contents associated with the electronic files is illustrated in FIG. 6. As shown in FIG. 6, the blocks with patterned background represent the subclasses where the set of methods are selected from in the following embodiments A-Q. Specially, referring together with FIGS. 5 and 6, the DRM agent module 20 may be installed in the net module in the embodiment A, installed in the content module in the embodiments B, C, D, L and M, installed in the webkit glue module in the embodiments E, K, N, O, P, Q or installed in the webkit module in the embodiments F, G, H, I, J, respectively.

In the embodiment A, the installation of the DRM agent module 20 in the net module 12 may be implemented to perform the operations of the normal Start, GetMimeType, ReadRawData and Kill method of the URLRequestFileJob or URLRequestHttpJob subclass in the net module 12 as described above.

In the embodiment B, the installation of the DRM agent module 20 in the content module may be implemented in a set of the OnResponseStarted method and OnReadCompleted method of the ResourceLoader class. The OnResponseStarted method is overwritten to activate the DRM agent module 20 for obtaining the MIME type and data size of the electronic file, replacing the MIME type and the data size contained in a ResourceResponse object created by the OnResponseStarted method with the obtained MIME type and data size of the electronic file and passing the ResourceResponse object to the next class (i.e. the ResourceDispatcherHost class) in the sequence. The OnReadCompleted method is overwritten to request for a memory block, activate the DRM agent module 20 for processing the DRM-protected content to obtain the electronic file, determine the length and location of the electronic file in the memory and store it in the memory block, and pass the content and length of the obtained electronic file to the next class (i.e. the ResourceDispatcherHost class) in the sequence. The OnReadCompleted method is further overwritten to activate the DRM agent module 20 for closing the access to the electronic file if the length of the electronic file is zero.

In the embodiment C, the installation of the DRM agent module 20 in the content module may be implemented in a set of the DidReceiveResponse method and DidFinishLoading method of the ResourceDispatcherHost class. The DidReceiveResponse method is overwritten to activate the DRM agent module 20 for obtaining the MIME type and data size of the electronic file, replacing the MIME type and the data size contained in a ResourceRequestInfoImpl object with the obtained MIME type and data size of the electronic file and passing the ResourceRequestInfoImpl object to the next class (i.e. the ResourceDispatcher class) in the sequence. The DidFinishLoading method is overwritten to activate the DRM agent module 20 for closing the access to the electronic file, when finishing the loading of the DRM-protected content in the class.

In the embodiment D, the installation of the DRM agent module 20 in the content module may be implemented in a set of the OnReceivedResponse method, OnReceivedData method, and OnRequestComplete method of the ResourceDispatcher class. The OnReceivedResponse method is overwritten to activate the DRM agent module 20 for obtaining the MIME type and data size of the electronic file, replacing the MIME type and the data size contained in a ResourceResponseHead object with the obtained MIME type and data size of the electronic file and passing the ResourceResponseHead object to the next class (i.e. the WebURLLoaderImpl class) in the sequence. The OnReceivedData method is overwritten to request for a memory block, activate the DRM agent module 20 for processing the DRM-protected content to obtain the electronic file and store it in the memory block and passing the content and length of the obtained electronic file to the next class (i.e. the WebURLLoaderImpl class) in the sequence. The OnRequestComplete method is overwritten to activate the DRM agent module 20 for closing the access to the electronic file, when finishing the loading of the DRM-protected content in the class.

In the embodiment E, the installation of the DRM agent module 20 in the webkit glue module may be implemented in a set of the OnReceivedResponse method, OnReceivedData method, and OnCompleteRequest method of the WebURLLoaderImp class. The OnReceivedResponse method is overwritten to activate the DRM agent module 20 for obtaining the MIME type and data size of the electronic file, replacing the MIME type and the data size contained in a ResourceResponseInfo object with the obtained MIME type and data size of the electronic file and passing the ResourceResponseInfo object to the next class (i.e. the ResourceHandleInternal class) in the sequence. The OnReceivedData method is overwritten to request for a memory block, activate the DRM agent module 20 for processing the DRM-protected content to obtain the electronic file and store it in the memory block and passing the content and length of the obtained electronic file to the next class (i.e. the ResourceHandleInternal class) in the sequence. The OnCompleteRequest method is overwritten to activate the DRM agent module 20 for closing the access to the electronic file, when finishing the loading of the DRM-protected content in the class.

In the embodiment F, the installation of the DRM agent module 20 in the webkit module may be implemented in a set of the didReceiveResponse method, didReceiveData method, and didFinishLoading method of the ResourceHandleInternal class. The didReceiveResponse method is overwritten to activate the DRM agent module 20 for obtaining the MIME type and data size of the electronic file, replacing the MIME type and the data size contained in a WebURLResponse object with the obtained MIME type and data size of the electronic file and passing the WebURLResponse object to the next class (i.e. the MainResourceLoader class) in the sequence. The didReceiveData method is overwritten to request for a memory block, activate the DRM agent module 20 for processing the DRM-protected content to obtain the electronic file and store it in the memory block and passing the content and length of the obtained electronic file to the next class (i.e. the MainResourceLoader class) in the sequence. The didFinishLoading method is overwritten to activate the DRM agent module 20 for closing the access to the electronic file, when finishing the loading of the DRM-protected content in the class.

In one embodiment G, the installation of the DRM agent module 20 in the webkit module may be implemented in a set of the didReceiveResponse method, didReceiveData method, and didFinishLoading method of the MainResourceLoader class. The didReceiveResponse method is overwritten to activate the DRM agent module 20 for obtaining the MIME type and data size of the electronic file, replacing the MIME type and the data size contained in an object with the obtained MIME type and data size of the electronic file and passing the object to the subsequent class (e.g. DocumentLoader and FrameLoader classes) in the sequence. The didReceiveData method is overwritten to request for a memory block, activate the DRM agent module 20 for processing the DRM-protected content to obtain the electronic file and store it in the memory block and passing the content and length of the obtained electronic file to the subsequent class in the sequence. The didFinishLoading method is overwritten to activate the DRM agent module 20 for closing the access to the electronic file, when finishing the loading of the DRM-protected content in the class.

In the embodiment H, the installation of the DRM agent module 20 in the webkit module may be implemented in a set of the commitLoad method, and/or finishedLoading method of the DocumentLoader class. The commitLoad method is overwritten to activate the DRM agent module 20 for obtaining the MIME type and data size of the electronic file, replacing the MIME type and the data size contained in a ResourceResponse object with the obtained MIME type and data size of the electronic file object and passing the ResourceResponse object to the next class (i.e. the FrameLoaderClientImpl class) in the sequence. The committedLoad method is further overwritten to request for a memory block, activate the DRM agent module 20 for processing the DRM-protected content to obtain the electronic file and store it in the memory block and passing the content and length of the obtained electronic file to the next class (i.e. the FrameLoaderClientImpl class) in the sequence. The finishedLoading method is overwritten to activate the DRM agent module 20 for closing the access to the electronic file, when finishing the loading of the DRM-protected content in the class.

In the embodiment I, the installation of the DRM agent module 20 in the webkit module may be implemented in a set of the commitLoad method, and finishedLoading method of the FrameLoaderClientlmpl class. The commitLoad method is overwritten to activate the DRM agent module 20 for obtaining the MIME type and data size of the electronic file, replacing the MIME type and the data size contained in a ResourceResponse object with the obtained MIME type and data size of the electronic file object and passing the ResourceResponse object to the next class (i.e. the WebPluginContainerImpl class) in the sequence. The committedLoad method is further overwritten to request for a memory block, activate the DRM agent module 20 for processing the DRM-protected content to obtain the electronic file and store it in the memory block and passing the content and length of the obtained electronic file to the next class (i.e. the WebPluginContainerImpl class) in the sequence. The finishedLoading method is overwritten to activate the DRM agent module 20 for closing the access to the electronic file, when finishing the loading of the DRM-protected content in the class.

In the embodiment J, the installation of the DRM agent module 20 in the webkit module may be implemented in a set of the didReceiveResponse method, didReceiveData method and/or didFinishLoading method of the WebPluginContainerImpl class. The didReceiveResponse method is overwritten to activate the DRM agent module 20 for obtaining the MIME type and data size of the electronic file, replacing the MIME type and the data size contained in a ResourceResponse object with the obtained MIME type and data size of the electronic file and passing the ResourceResponse object to the next class (i.e. the WebPluginImpl class) in the sequence. The didReceiveData method is overwritten to request for a memory block, activate the DRM agent module 20 for processing the DRM-protected content to obtain the electronic file and store it in the memory block and passing the content and length of the obtained electronic file to the next class (i.e. the WebPluginImpl class) in the sequence. The didFinishLoading method is overwritten to activate the DRM agent module 20 for closing the access to the electronic file, when finishing the loading of the DRM-protected content in the class.

In the embodiment K, the installation of the DRM agent module 20 in the webkit glue module may be implemented in a set of the didReceiveResponse method, didReceiveData method and didFinishLoading method of the WebPluginImpl class. The didReceiveResponse method is overwritten to activate the DRM agent module 20 for obtaining the MIME type and data size of the electronic file, replacing the MIME type and the data size contained in a WebURLResponse object with the obtained MIME type and data size of the electronic file and passing the WebURLResponse object to the next class (i.e. the WebPluginDelegateProxy class) in the sequence. The didReceiveData method is overwritten to request for a memory block, activate the DRM agent module 20 for processing the DRM-protected content to obtain the electronic file and store it in the memory block and passing the content and length of the obtained electronic file to the next class (i.e. the WebPluginDelegateProxy class) in the sequence. The didFinishLoading method is overwritten to activate the DRM agent module 20 for closing the access to the electronic file, when finishing the loading of the DRM-protected content in the class.

In the embodiment L, the installation of the DRM agent module 20 in the content module may be implemented in a set of the DidReceiveManualResponse method, DidReceiveManualData method, and/or DidFinishManualLoading method of the WebPluginDelegateProxy class. The DidReceiveManualResponse method is overwritten to activate the DRM agent module 20 for obtaining the MIME type and data size of the electronic file, replacing the MIME type and the data size contained in an object with the obtained MIME type and data size of the electronic file to create a PluginMsg_DidReceiveResponseParams object and passing the PluginMsg_DidReceiveResponseParams object to the next class (i.e. the WebPluginDelegateStub class) in the sequence. The DidReceiveManualData method is overwritten to request for a memory block, activate the DRM agent module 20 for processing the DRM-protected content to obtain the electronic file and store it in the memory block and passing the content and length of the obtained electronic file to the next class (i.e. the WebPluginDelegateStub class) in the sequence. The DidFinishManualLoading method is overwritten to activate the DRM agent module 20 for closing the access to the electronic file, when finishing the loading of the DRM-protected content in the class.

In the embodiment M, the installation of the DRM agent module 20 in the content module may be implemented in a set of the OnDidReceiveManualResponse method, OnDidReceiveManualData method, and OnDidFinishManualLoading method of the WebPluginDelegateStub class. The OnDidReceiveManualResponse method is overwritten to activate the DRM agent module 20 for obtaining the MIME type and data size of the electronic file, replacing the MIME type and the data size contained in a PluginMsg_DidReceiveResponseParams object with the obtained MIME type and data size of the electronic file and passing the PluginMsg_DidReceiveResponseParams object to the next class (i.e. the WebPluginDelegateImpl class) in the sequence. The OnDidReceiveManualData method is overwritten to request for a memory block, activate the DRM agent module 20 for processing the DRM-protected content to obtain the electronic file and store it in the memory block and passing the content and length of the obtained electronic file to the next class (i.e. the WebPluginDelegateImpl class) in the sequence. The OnDidFinishManualLoading method is overwritten to activate the DRM agent module 20 for closing the access to the electronic file, when finishing the loading of the DRM-protected content in the class.

In the embodiment N, the installation of the DRM agent module 20 in the webkit glue module may be implemented in a set of the DidReceiveManualResponse method, DidReceiveManualData method, and DidFinishManualLoading method of the WebPluginDelegateImpl class. The DidReceiveManualResponse method is overwritten to activate the DRM agent module 20 for obtaining the MIME type and data size of the electronic file, replacing the MIME type and the data size contained in a MIMEType object with the obtained MIME type and data size of the electronic file and passing the MIMEType object to the next class (i.e. the PluginInstance class) in the sequence. The DidReceiveManualData method is overwritten to request for a memory block, activate the DRM agent module 20 for processing the DRM-protected content to obtain the electronic file and store it in the memory block and passing the content and length of the obtained electronic file to the next class (i.e. the PluginInstance class) in the sequence. The DidFinishManualLoading method is overwritten to activate the DRM agent module 20 for closing the access to the electronic file, when finishing the loading of the DRM-protected content in the class.

In the embodiment O, the installation of the DRM agent module 20 in the webkit glue module may be implemented in a set of the DidReceiveManualResponse method, DidReceiveManualData method, and DidFinishManualLoading method of the PluginInstance class. The DidReceiveManualResponse method is overwritten to activate the DRM agent module 20 for obtaining the MIME type and data size of the electronic file, creating a PluginStreamUrl object with the obtained MIME type and data size of the electronic file and passing the PluginStreamUrl object to the next class (i.e. the PluginStreamUrl class) in the sequence. The DidReceiveManualData method is overwritten to request for a memory block, activate the DRM agent module 20 for processing the DRM-protected content to obtain the electronic file and store it in the memory block and passing the content and length of the obtained electronic file to the next class (i.e. the PluginStreamUrl class) in the sequence. The DidFinishManualLoading is overwritten to activate the DRM agent module 20 for closing the access to the electronic file, when finishing the loading of the DRM-protected content in the class.

In the embodiment P, the module may be a webkit glue module and the installation of the DRM agent module 20 in the webkit glue module may be implemented in a set of the DidReceiveResponse method, DidReceiveData method, and DidFinishLoading method of the PluginStreamUrl class. The DidReceiveResponse method is overwritten to activate the DRM agent module 20 for obtaining the MIME type and data size of the electronic file, replacing the MIME type and the data size contained in an object with the obtained MIME type and data size of the electronic file and passing the object to the next class (i.e. the PluginStream class) in the sequence. The DidReceiveData method is overwritten to request for a memory block, activate the DRM agent module 20 for processing the DRM-protected content to obtain the electronic file and store it in the memory block and passing the content and length of the obtained electronic file to the next class (i.e. the PluginStream class) in the sequence. The DidFinishLoading is overwritten to activate the DRM agent module 20 for closing the access to the electronic file, when finishing the loading of the DRM-protected content in the class.

In the embodiment Q, the module may be a webkit glue module and the installation of the DRM agent module 20 in the webkit glue module may be implemented in a set of the Open method, Write method, and Close method of the PluginStream class. The Open method is overwritten to activate the DRM agent module 20 for obtaining the MIME type and data size of the electronic file, replacing the MIME type and the data size contained in an object with the obtained MIME type and data size of the electronic file and passing the object to the next class in the sequence. The Write method is overwritten to request for a memory block, activate the DRM agent module 20 for processing the DRM-protected content to obtain the electronic file and store it in the memory block and passing the content and length of the obtained electronic file to the next class in the sequence. The Close method is overwritten to activate the DRM agent module 20 for closing the access to the electronic file, when finishing the loading of the DRM-protected content in the class.

Therefore, the methods and apparatuses of the application can solve the prior art problems concerning the installation of DRM agents to the plurality of software applications by using DRM in the specific module which may be invoked during the loading of the DRM-protected content of a web browser, such as the Firefox, Chrome, Opera, or Safari web browser, etc., for the Windows system.

It is to be understood that, although the Chromium web browser is used as an exemplary web browser in the embodiments, another web browser may be used instead, such as a Firefox, Internet Explorer, Opera, Safari, or a web browser constructed by Web Kit or Web View SDK bearing similar functions of the aforementioned ones, etc., and the invention is not limited thereto.

While the invention has been described by way of example and in terms of preferred embodiment, it is to be understood that the invention is not limited thereto. Those who are skilled in this technology can still make various alterations and modifications without departing from the scope and spirit of this invention. It is also noted that the version of a browser software might be changed and the nomenclature of modules, methods, classes might as well be changed or their functions might be reorganized and re-casted, but as long as the basic functionalities necessary for the deploying of DRM agent remain, the method taught in this invention still can be applied. Therefore, the scope of the invention shall be defined and protected by the following claims and their equivalents.

What is claimed is:

1. An electronic device for processing file content using Digital Rights Management (DRM), comprising:
a DRM agent, processing DRM-protected content associated with an electronic file;
a plug-in, enabling access of the electronic file; and
a web browser, comprising a module which is configured to be invoked during loading of the DRM-protected content associated with the electronic file and during loading of the electronic file without DRM protection, the module is installed with the DRM agent,
wherein the module determines whether the electronic file is DRM protected upon receiving a request for the electronic file and when determining that the electronic file is DRM protected, activates the processing of the DRM-protected content by the DRM agent to obtain the electronic file portion-by-portion such that the web browser directly accesses or uses a corresponding native player or a corresponding plug-in of the web browser to access the electronic file with the obtained portions, respectively,
wherein the processing of the DRM-protected content is activated when the web browser is required to access the DRM-protected content.

2. The electronic device of claim 1, wherein the module further determines whether the electronic file is DRM protected using one of a plurality of DRM schemes according to a file extension of the electronic file.

3. The electronic device of claim 2, wherein the module further determines whether the electronic file is DRM protected using a specific API of one of a plurality

4. The electronic device of claim 1, wherein the module activates the DRM agent to activate the processing of the DRM-protected content of the DRM agent using the Application Programming Interfaces (APIs) of the DRM agent.

5. The electronic device of claim 1, wherein the DRM agent is installed in a set of methods or classes in the module, which are to be invoked during the loading of the DRM-protected content associated with the electronic file, so that the processing of the DRM-protected content is activated when the web browser is required to access the DRM-protected content associated with the electronic file.

6. The electronic device of claim 5, wherein the web browser is a Chromium web browser and the module is at least one of a net module, a webkit module, a webkit glue module and a content module, which are invoked during the loading of the DRM-protected content associated with the electronic file and defined in the Chromium web browser.

7. The electronic device of claim 6, wherein the set of methods comprises a Start method, a GetMimeType method, a ReadRawData method and a Kill method in the net module for activating the DRM agent for the processing of the DRM-protected content, wherein the processing comprises: opening access to the electronic file, moving a file-reading pointer to a location of the electronic file; determining a length of reading for the electronic file; requesting for a memory block according to the length of reading for the electronic file; obtaining the electronic file portion-by-portion from the file-reading pointer; obtaining a Multipurpose Internet Mail Extensions (MIME) type of the electronic file; storing the obtained portions in the memory block; and closing the access to the electronic file.

8. The electronic device of claim 1, wherein the module further receives the DRM-protected content remotely from the Internet or locally from a memory device

9. A method for processing file content using Digital Rights Management (DRM) in an electronic device, comprising:
providing a web browser comprising a module which is configured to be invoked during loading of the DRM-protected content associated with an electronic file and during loading of the electronic file without DRM protection, and the module is installed with the DRM agent for processing DRM-protected content associated with the electronic file;
determining, by the module, whether the electronic file is DRM protected upon receiving a request for the electronic file; and
activating, by the module, the processing of the DRM-protected content by the DRM agent to obtain the electronic file portion-by-portion, so as to directly access or use a corresponding native player or a corresponding plug-in of the web browser to access, by the web browser, the electronic file with the obtained portions, respectively when determining that the electronic file is DRM protected,
wherein the processing of the DRM-protected content is activated when the web browser is required to access the DRM-protected content.

10. The method of claim 9, wherein the step of determining whether the electronic file is DRM protected by the module further comprises:
determining, by the module, whether the electronic file is DRM protected using one of a plurality of DRM schemes according to a file extension or a specific field in a header of the electronic file.

11. The method of claim 9, wherein the DRM agent is activated by the module to activate the processing of the DRM-protected content of the DRM agent using the Application Programming Interfaces (APIs) of the DRM agent when determining that the electronic file is DRM protected.

12. The method of claim 9, wherein the DRM agent is installed in a set of methods or classes in the module, which are to be invoked during the loading of the DRM-protected content associated with the electronic file, so that the processing of the DRM-protected content is activated when the web browser is required to access the DRM-protected content associated with the electronic file.

13. The method of claim 12, wherein the web browser is a Chromium web browser and the module is at least one of a net module, a webkit module, a webkit glue module and a content module, which are invoked during the loading of the DRM-protected content associated with the electronic file and defined in the Chromium web browser.

14. The method of claim 13, wherein the set of methods comprises a Start method, a GetMimeType method, a ReadRawData method and a Kill method in the net module, and the step of activating the processing of the DRM-protected content of the DRM agent to obtain the electronic file portion-by-portion by the module further comprises:
activating, by the Start method, the GetMimeType method, the ReadRawData method and the Kill method, the DRM agent for the processing of the DRM-protected content,
wherein the processing comprises opening access to the electronic file, moving a file-reading pointer to a location of the electronic file, determining a length of reading for the electronic file, requesting for a memory block according to the length of reading for the electronic file, obtaining the electronic file portion-by-portion from the file-reading pointer, obtaining a Multipurpose Internet Mail Extensions (MIME) type of the electronic file, storing the obtained portions in the memory block, and closing the access to the electronic file.

15. An electronic device for processing file content using Digital Rights
a plurality of DRM agents supporting a plurality of DRM schemes, processing DRM-protected content associated with an electronic file using one of the DRM schemes;
a plurality of plug-ins, enabling access of the corresponding electronic files; and
a web browser, comprising a module which is configured to be invoked during loading of the DRM-protected content associated with the electronic file and during loading of the electronic file without DRM protection, the module is installed with the DRM agents,
wherein the module determines whether the electronic file is DRM protected upon receiving a request for the electronic file and determines a specific DRM scheme of the DRM schemes which is used to protect the electronic file, when determining that the electronic file is DRM protected by the specific DRM scheme, activates the processing of the DRM-protected content by the corresponding DRM agent supporting the specific DRM scheme in the DRM module to obtain the electronic file portion-by-portion such that the browser directly accesses or uses a corresponding native player or a corresponding plug-in of the web browser to access the electronic file with the obtained portions, respectively,
wherein the processing of the DRM-protected content is activated when the web browser is required to access the DRM-protected content.

16. The electronic device of claim 15, wherein the module further determines whether the electronic file is DRM protected and determines the specific DRM scheme of the DRM schemes which is used to protect the electronic file using one of the plurality of DRM schemes according to a file extension of the electronic file or according to a specific field in a header of the electronic file.

17. The electronic device of claim 15, wherein the module activates the DRM agent to activate the processing of the DRM-protected content of the corresponding DRM agent using the Application Programming Interfaces (APIs) of the corresponding DRM agent.

18. The electronic device of claim 15, wherein the DRM agents are installed in a set of methods or classes in the module, which are to be invoked during the loading of the DRM-protected content associated with the electronic file, so that the processing of the DRM-protected content is activated when the web browser is required to access the DRM-protected content associated with the electronic file.

19. The electronic device of claim 18, wherein the web browser is a Chromium web browser and the module is at least one of a net module, a webkit module, a webkit glue module and a content module, which are invoked during the loading of the DRM-protected content associated with the electronic file and defined in the Chromium web browser.

20. The electronic device of claim 19, wherein the set of methods comprises a Start method, a GetMimeType method, a ReadRawData method and a Kill method in the net module for activating the DRM agent for the processing of the DRM-protected content, wherein the processing comprises: opening access to the electronic file, moving a file-reading pointer to a location of the electronic file; determining a length of reading for the electronic file; requesting for a memory block according to the length of reading for the electronic file; obtaining the electronic file portion-by-portion from the file-reading pointer; obtaining a Multipurpose Internet Mail Extensions (MIME) type of the electronic file; storing the obtained portions in the memory block; and closing the access to the electronic file.
